(19) United States
(12) Patent Application Publication
(10) Pub. No.: US 2008/0043895 A1
(43) Pub. Date: Feb. 21, 2008

(54) Electromagnetic radiation-initiated plasma reactor

(76) Inventors: Stephen H. Shehane, Smiths, AL (US); Rick Bernard Spielman, Tijeras, NM (US); Jean-francais P. Leon, Route de Lacapelle (FR); Mike Fraim, Corrales, NM (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/708,199

(22) Filed: Feb. 20, 2007

Related U.S. Application Data
(63) Continuation of application No. 11/472,599, filed on Jun. 22, 2006, now abandoned.
Application No. 11/472,599 is a continuation of application No. 10/934,562, filed on Sep. 7, 2004, now abandoned.
Application No. 10/934,562 is a continuation of application No. 10/336,689, filed on Jan. 6, 2003, now abandoned.
Application No. 10/336,689 is a continuation of application No. PCT/US01/21285, filed on Jul. 5, 2001.
Application No. 10/336,689 is a continuation-in-part of application No. 09/609,624, filed on Jul. 5, 2000, now abandoned.
Application No. 10/336,689 is a continuation-in-part of application No. 09/610,214, filed on Jul. 5, 2000, now abandoned.
Application No. 10/336,689 is a continuation-in-part of application No. 09/679,819, filed on Oct. 5, 2000, now abandoned.

(51) Int. Cl. G21B 1/00

(52) U.S. Cl. 376/103

(57) ABSTRACT

A reactor and method is disclosed that creates a stabilized, heated plasma and generates a large amount of thermal energy. The initial plasma may be created by heating, either through combustion reactions and/or external heating mechanism, a fuel which is a source of hydrogen ions and air (or oxygen) inside the reactor chamber, and then locally ionizing the hot matter with an external source of radiation, such as a laser and/or an electrical discharge and/or microwave discharge. A gas vortex around the plasma mass may be maintained to control the plasma mass, shape, and location. When the reaction is performed in the presence of certain mid-Z elements, such as lithium, beryllium, boron, nitrogen, or fluorine, the reactor is observed to generate a steady-state energy output up to and greater than 100 kW providing an energy output at least a factor of about 1 and typically a factor of about 10 or greater than the energy input into the reactor that would be caused by conventional combustion of the fuels including the energy input from the external source of radiation.

### TECHNICAL FIELD

This invention relates generally to the field of energy production and, more particularly, to a reactor and reactions that may generate energy. The reactor and reaction may involve the generation of plasma.

### BACKGROUND OF THE INVENTION

The world is in great need of pollution-free low-cost energy sources, and a great deal of research has been targeted into such areas as solar generated power, wind power, biomass power production, and nuclear fusion. Despite years of research and heavy investment, a nuclear fusion reaction that is self-sustaining for any considerable length of time has not yet been achieved. In addition, nuclear fusion reactors are not yet commercially viable due to high costs of energy input to initiate the reactions and necessary containment systems for the extremely high temperatures associated with such reactions.

### SUMMARY OF THE INVENTION

We have found that a self-sustaining reaction can be initiated in a plasma containing hydrogen ions and specific mid-Z elements by an electromagnetic source, such as a laser, and a high voltage discharge. Further, the reaction creates energy output substantially always at least equal to about 1 and regularly at least about 10 times the power that would be caused by conventional combustion of the fuel including the input of energy into the reaction. In addition, no ionizing radiation has been observed in the exhaust gases, although there is a significant presence of He⁴, a known nuclear fusion byproduct.

It is an object of the invention to create a self-sustaining energy producing reaction from a plasma containing hydrogen ions and specific mid-Z elements, initiated by an electromagnetic input, such as a laser, and high voltage discharge.

It is another object of the invention to create a self-sustaining energy reaction capable of generating at least about 10 times more energy than would be caused by conventional combustion of the fuels, including input energy.

It is another object of the invention to create a self-sustaining energy reaction that does not produce significant amounts of ionizing radiation.

It is yet another object of the invention to provide an apparatus for carrying out a self-sustaining energy reaction that generates at least about 10 times more energy than would be caused by conventional combustion of the fuels, including input energy and that does not produce measurable amounts of ionizing radiation.

The following paragraphs set forth definitions for many of the terms used throughout this application. The scientific and/or technical terms in this application not specifically defined herein are used within their commonly accepted definitions in the fields of Electromagnetic Theory and Plasma Physics.

Medium- or Mid-Z Elements: Elements having an atomic number, Z=3-18, including all naturally occurring isotopes and ions of those elements, where Z is the number of protons in the nucleus (the atomic number).

Partially ionized: A condition in which some of the atoms in a plasma have at least one electron removing from them making them ions.

Plasma: A state of matter characterized as an electrified gas composed of unbound negative electrons and positive ions.

Electromagnetic radiation: Energy composed of electric and magnetic fields that propagates at the speed of light. This radiation extends from the radio spectrum (long wavelengths) to x and gamma radiation (very short wavelengths).

Generally described, one embodiment of the invention is a reactor capable of generating a steady-state thermal power output up to and greater than 100 kW when the ratio of the output power to the input power into the system (including chemical, electrical, and electromagnetic, i.e., total input power) is between 1 and approximately 10. The reaction is created by injecting a combustion fuel comprising hydrogen ions and a source of oxygen, such as air, into a combustion zone (which may be in a containment vessel), igniting the fuel to create a hot gas mass, directing at least one energy source (also referred to herein as an electromagnetic radiation source), such as a laser beam, a microwave source, a radio frequency source or an electron beam, into a hot gas mass to at least partially ionize the gases, initiating a high-voltage discharge through the gas mixture to complete formation of a plasma, continuing to direct the electromagnetic radiation source and the high-voltage discharge through the plasma, and stabilizing the plasma with a rotating vortex of gas around the plasma. The electromagnetic energy source should deliver from about 0 to about 0.60, preferably about 0.01 to about 0.02 of KW per mole of H into the reaction vessel. A vortex of gas may be created around the plasma by injecting gas. When this reaction is initiated and conducted in the presence of specific mid-Z elements, as for example Li, Be, N, B, or F, it generates substantial levels of thermal energy, which may be nuclear in origin.

In one embodiment, the above-described reaction produces a self-sustaining source of energy which has a net energy gain at least equal to about 1, preferably equal to at least about 10, as compared to a thermal output which would be generated by conventional combustion of fuels, including (i.e., taking into account) the energy in the electromagnetic radiation source and the source of high voltage (i.e., total input power).

The combustion fuel may include, for example, diesel fuel, and the gas vortex may include oxygen. The electromagnetic radiation source may be a CO₂ laser. Other materials such as boron are included in the plasma (by injection or other means) to initiate the energy generating reactions.

The combustion fuel is typically injected into the combustion zone of the containment vessel from a plurality of rotational aspects (i.e., points or directions) around the combustion zone. For example, the reactor (or containment vessel) may include two tiers of fuel injectors with four fuel injectors spaced 90° apart in each tier. The fuel injectors may be placed circumferentially around the combustion zone of the reactor vessel. Similarly, the gases that form the gas vortex are typically injected around the plasma from a plurality of rotational aspects around the combustion zone. For example, the reactor may include three tiers of gas injectors with four fuel injectors spaced 90° apart in each tier. Such gas injectors may also be placed circumferentially around the combustion zone.

Electricity may be generated from the reactor, for example, by driving a turbine and/or thermal energy extracted from the reactor through a cooling system.

In one embodiment of the invention, a laser-initiated plasma reactor includes a containment vessel containing one or more fuel injectors for injecting a combustion fuel to create a mass of hot gas within a combustion zone in the reactor vessel. A CO₂ laser beam is directed into the hot gas to at least partially ionize the gas and a high voltage source may be used to drive a discharge through the gas to ionize the gas and generate a plasma. One or more injectors introduce a gas vortex around the plasma mass to contain the plasma within the combustion zone. The reactor may have a cooling system, and an exhaust port.

In one embodiment of the invention, the containment vessel walls may include alumina (Al₂O₃) comprising approximately 1.5 to about 2% borate. A crystal or crystal matrix containing ceramic oxide, such as Corundum crystals, may be positioned adjacent to the combustion zone and act as a target for the laser. The high voltage source may be connected to the crystal or crystal matrix as the cathode, and the anode may be located substantially across the reactor.

In one embodiment of the invention, a system including the reactor may also include an electric generation system, such as an electric generator, powered by thermal energy generated by the reactor. The system may also include at least one of a turbine, a jet engine, or a rocket engine powered by the exhaust gas generated by the system or otherwise by energy generated by the system.

Thus, one embodiment of a laser-initiated plasma reactor may include a means for creating plasma from combustion gases, a means for stabilizing the plasma within the containment vessel, a means for adding additional materials to the plasma, and a means for causing the plasma to generate heat through specific reactions. The reactor may also include means for generating electricity from thermal energy released by the reactor. It is believed, without limiting the invention to any operability theory, that the heat may be the result of nuclear fusion reactions between hydrogen ions and specific mid-Z elements.

Another embodiment of the invention is directed to an apparatus comprising a reactor vessel including: interior ceramic walls, at least one fuel injector, at least one injector for injecting a source of oxygen, such as air or oxygen into the reactor, a source of at least one mid-Z element, a source of electromagnetic radiation. The reactor also includes a target for the source of electromagnetic radiation, and a source of high voltage, such as a high voltage DC source. The target for the source of electromagnetic radiation may be a cathode for the source of high voltage. The reactor further includes an anode for the high voltage source, placed substantially opposite the cathode. At least one injector for injecting a gas to create a rotating gas vortex is also included in the reactor, as well as a reactor vessel cooling system and an exhaust port.

In a two-chamber embodiment a laser-initiated plasma reactor includes primary and secondary reactors. Each reactor comprises a containment vessel including one or more fuel injectors for injecting a combustion fuel to create a mass of hot gas within a combustion zone in the containment vessel. A CO₂ laser beam is directed into the hot gas to partially ionize the gas. A high voltage source may be used to drive a discharge through the gas to ionize the gas. One or more injectors introduce a gas vortex around the plasma mass to contain the plasma within the combustion zone.

It should be understood that additional reactors could be connected together in the manner described above to create a machine (or apparatus) with three, four, or more parallel reactors.

The advantages described above will become apparent from the following detailed description of embodiments of the subject invention and the appended drawings and claims.

### BRIEF DESCRIPTION OF THE DRAWINGS

The invention will be described with reference to the accompanying drawings, in which like elements are referenced with like numerals, with the exception of FIG. 17.

FIG. 1 is a diagram illustrating the basic configuration of a laser-initiated plasma reactor in accordance with the invention.

FIG. 2 is a diagram illustrating the laser sources within a laser-initiated plasma reactor in accordance with the invention.

FIG. 3 is a block diagram illustrating exhaust recirculation in a laser-initiated plasma reactor including two substantially closed containment vessels.

FIG. 4 is a side view of a containment vessel illustrating the location of the fuel injectors in a laser-initiated plasma reactor in accordance with the invention.

FIG. 5 is a top view of a containment vessel illustrating the location of the fuel injectors in a laser-initiated plasma reactor in accordance with the invention.

FIG. 6 is a side view of a containment vessel illustrating the location of the gas injectors in a laser-initiated plasma reactor in accordance with the invention.

FIG. 7 is a top view of a containment vessel illustrating the location of the gas vortex injectors in a laser-initiated plasma reactor in accordance with the invention.

FIG. 8 is a side view of a containment vessel illustrating the location of the recirculation air ports in a laser-initiated plasma reactor.

FIG. 9 is a top view of a containment vessel illustrating the location of the recirculation air ports in a laser-initiated plasma reactor.

FIG. 10 is a side view of a crystal matrix for use in a laser-initiated plasma reactor.

FIG. 11 is a top view of the crystal matrix of FIG. 10.

FIG. 12 is a side view of a crystal from the crystal matrix of FIG. 10.

FIG. 13 is a top view of the crystal of FIG. 12.

FIG. 14 is a block diagram of a laser-initiated plasma reactor system including electric generation equipment, exhaust processing equipment, and air handling equipment.

FIG. 15 is a block diagram of an instrumentation and control system for a laser-initiated plasma reactor.

FIG. 16 is a logic flow diagram illustrating a method for operating a laser-initiated plasma reactor.

FIG. 17 is a block diagram illustrating an experimental two-reactor prototype machine constructed to demonstrate the operation of a laser-initiated plasma reactor.

FIG. 18 is a front side view of a two-reactor prototype machine.

FIG. 19 is a front side view of one of the reactors of the prototype machine shown in FIG. 18.

FIG. 20 is a top view of the reactors of the prototype machine shown in FIG. 18.

FIG. 21 is a top view of one of the reactors of the protorype machine shown in FIG. 18 illustrating internal components of the reactors.

FIGS. 22a-f illustrate the configuration of the fuel injectors of the prototype machine shown in FIG. 18.

FIG. 23A-B illustrate the configuration of the high-voltage source of the prototype machine shown in FIG. 18.

FIG. 24 is a front side view of an alternative reactor including a pressurized-water cooling system.

FIG. 25 is a front side view illustrating an alternative configuration for a two-reactor laser-initiated plasma reactor including a pressurized-water cooling system.

FIG. 26 is a front side view of one reactor of the alternative two-reactor laser-initiated plasma reactor shown in FIG. 25 illustrating the cooling system embedded in the walls of the reactor.

FIGS. 27A-B include a table containing results for the energy balance test conducted for the prototype machine shown in FIG. 18.

FIG. 28 is a chart containing an atomic mass spectrum analysis-conducted from exhaust obtained from the prototype machine shown in FIG. 18.

FIG. 29 is a chart containing an atomic mass spectrum analysis conducted from ambient air near the prototype machine shown in FIG. 18.

FIG. 30 is a chart containing an atomic mass spectrum analysis conducted from exhaust obtained from the prototype machine shown in FIG. 18 illustrating the presence of He⁴ in the exhaust.

FIG. 31 is a chart containing an atomic mass spectrum analysis conducted for exhaust obtained from the prototype machine shown in FIG. 18 illustrating a spike in the He⁴ content in the exhaust.

FIG. 32 is a chart containing an atomic mass spectrum analysis conducted from exhaust obtained from the prototype machine shown in FIG. 18 illustrating the presence of He⁴ in the exhaust.

### DETAILED DESCRIPTION OF THE EMBODIMENTS

The combustion fuel may be any suitable fuel, such as a hydrocarbon. The combustion fuel may also be a source of hydrogen ions. The hydrocarbon may comprise at least one of diesel, kerosene, natural gas, methane, ethyl alcohol, gasoline or fuel oil. A mixture of fuels may also be used, and/or fuel may be mixed with water. Alternatively, hot gas may be created by externally heating in the reactor water in the presence of at least one mid-Z element, until the critical temperature is reached and plasma is formed. Thereafter, water is continuously introduced into the reactor and at least one mid-Z element continues to be present in the reactor or it is added. Water may also be a source of hydrogen ions. The source of oxygen may be air or oxygen. The high voltage discharge should be capable of delivering a voltage of about 1 to about 20, preferably about 10 to about 15 kV to the hot gas. A suitable device for delivering the high voltage discharge may be any commercially-available DC high voltage power supply. The rotating gas vortex may be formed from any one of the following gases, or a mixture thereof: oxygen, air, hydrogen, helium, argon, nitrogen, neon, or carbon dioxide, etc.

The reaction may be conducted at a wide range of pressures including lower than atmospheric, atmospheric and up to and including about 400 atmospheres. The pressure may also be in equilibrium with that outside the reactor vessel.

The mid-Z elements may be supplied to the reactor (and thus the reaction zone) in any suitable manner. For example, the mid-Z elements may be present on one or more structural components of the reactor vessel, such as walls, they may be introduced as a separate process stream into the vessel, or may be mixed with the air, the combustion fuel, or the vortex gases introduced into the vessel. The relative amounts of the hydrogen ions and mid-Z elements are about 1000 to about 1, preferably about 100 to about 50.

The method and apparatus of this invention produce a self-sustaining source of energy having a net energy gain at least equal to a factor of about 1, preferably at least equal to a factor of about 10. This means that the inventive method and apparatus generate at least the amount of thermal output equal to, and preferably at least about 10 times greater than, that which would be generated by conventional combustion of the fuels, including the energy of the electromagnetic radiation source and the high voltage discharge source.

The reactor vessel may include an external heat source to preheat the reactor vessel to improve the startup phase of the reactor. The source of electromagnetic radiation may be focused approximately at the center of the reactor vessel. If the source of electromagnetic radiation is a laser, a crystal laser target may be used. Such a crystal laser target may comprise a plurality of secondary crystals located within a ceramic container included in the reactor vessel. The crystal laser target may include a ceramic container, at least one crystal within the ceramic container and at least one electrode which is in electrical contact with the crystal in the ceramic container.

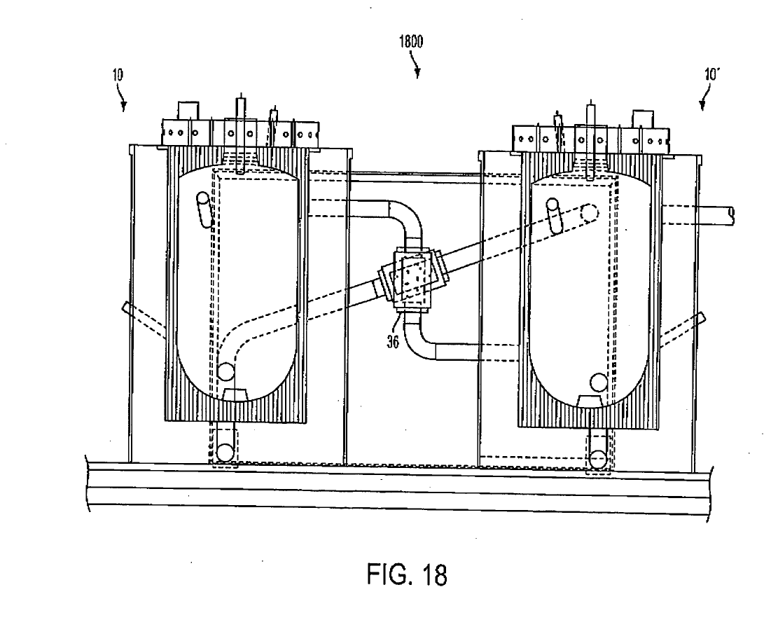

A preferred embodiment of the invention may be implemented as a laser-initiated plasma reactor that generates significant thermal energy without generating significant amounts of ionizing radiation. The experimental prototype reactor, shown in FIG. 18, has been constructed, fully instrumented, and tested. In the prototype reactor, a steady-state mass of hot gas can be created in a pair of containment vessels by injecting a combustion fuel atomized and mixed with ambient air, oxygen, or other gases into a combustion zone within each containment vessel. The combustion fuel typically includes diesel fuel, which may be mixed with ethyl alcohol and/or water.

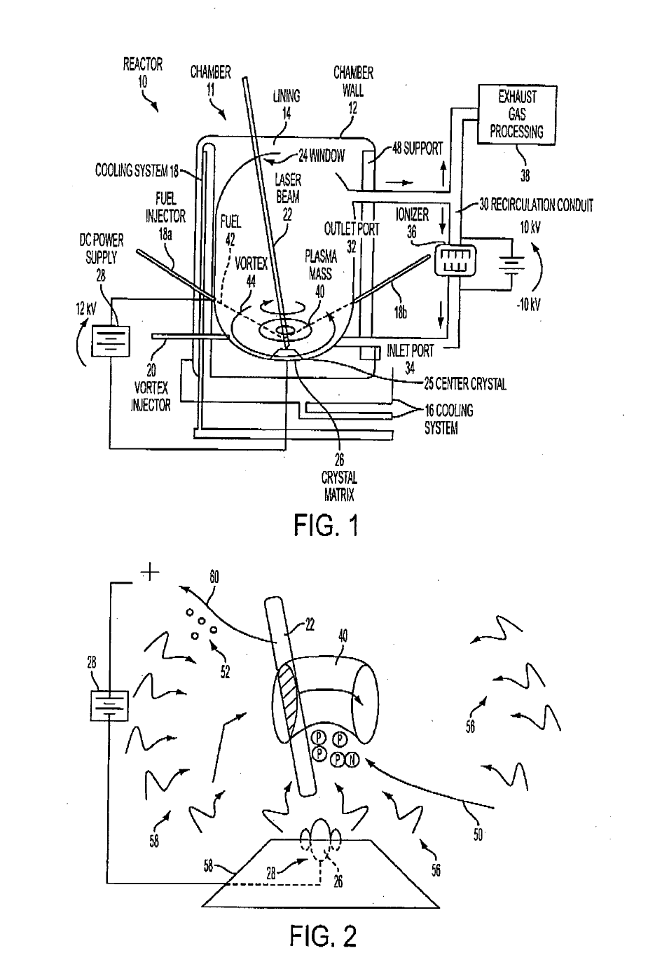

A plasma is created by injecting the combusting fuel into a region containing a CO₂ laser and having a large DC voltage (e.g. 12 kV). Typically, the range of voltages used were from 10 up to 15 kV. The plasma is suspended within the containment vessel and is prevented from coming in contact with the vessel inner wall using a rotating gas vortex injected into the containment vessel between the vessel wall and the plasma. This gas vortex typically includes a mixture of oxygen, ambient air, and/or other gases. It appears that combustion of the hydrocarbon fuels, such as diesel fuel and alcohol, brings the system up to a critical temperature where, in conjunction with the application of electromagnetic radiation, such as a laser or microwaves, and high voltage, energy production occurs. At this point, the laser and, optionally, the high-voltage source may be turned off and the reaction within the plasma should be self-sustaining. Once the reactor teaches this critical temperature, the reaction appears to be enhanced by decreasing the hydrocarbon fuel content, (such as the diesel fuel and ethyl alcohol), and increasing the water content in the fuel mixture. It is recommended that mid-Z elements such as lithium, beryllium, boron, nitrogen, and/or fluorine be added to the plasma or otherwise may be present in the reactor vessel. Salts or compounds maybe used as sources of the mid-Z elements. Exhaust gases may be recirculated into the reactor as shown in the schematic of the apparatus of the invention in FIG. 1, and the recirculated gases may be ionized before they are input input into the reactor vessel. Preferably, the exhaust gases are removed from the containment vessel.

The prototype machine includes two cylindrical reactors, each about 44 inches (106 cm) tall and 28 inches (71 cm) in diameter. A 3.25-kW CO₂ laser produces a beam that is split and directed into each reactor. In the prototype machine, the reactor walls are lined with alumina (Al₂O₃) containing approximately 1.5-2% borate (by weight) and the laser target crystals are formed from crystalline alumina (i.e., corundum crystals). A 12-kV DC voltage is applied between the crystal array and the top of the reactor chamber. Heat is removed from the outside of the reactor walls by a forced-air cooling system. In this system, air is directed through air jackets surrounding the walls of each reactor. Heat transfer is enhanced by a number of cooling fins that are partially embedded in the lining of the reactor wall and extend into the air jacket.

The experimental results of the prototype machine have been documented through instrumentation, energy balance tests, and exhaust stream analysis. The prototype machine produces temperatures in the walls of the containment vessel approaching 4,500° F. (2,482° C.), which is well above the temperatures that could be caused by conventional combustion of the fuels present in the plasma.

The prototype reactor can generate a steady-state thermal output of up to 1 megawatt (1,000 kW) while consuming only about 1.5 to 3 liters of diesel fuel per hour. This translates into an energy balance ratio (or net energy gain) above 10 meaning that the prototype machine generates about 10 times more thermal output than the amount that would be generated by conventional combustion of the fuels including the energy in the laser and the high-voltage supply. Without limiting the invention to any operability theory, it is believed that this excess energy may be the result of nuclear fusion reactions between hydrogen ions and specific mid-Z elements.

This belief that fusion reactions may be occurring is suggested by a significant and consistent presence of the nuclear fusion by product, He⁴ (two protons and two neutrons), in the exhaust of the reactor, while only trace amounts of He⁴ were detected in the ambient air prior to the activation of the plasma. Little or no ionizing radiation has been observed.

Without being bound to specific embodiments, in the prototype several features appear to enable these reactions. In particular, high wall temperatures, the application of the CO₂ laser, the presence of a large DC voltage, and the addition of some fuel mid-Z elements such as boron, lithium, beryllium, nitrogen, and/or fluorine appear to be needed to operate the prototype reactor.

It should be stated that the present understanding of the physics details of the reaction processes is limited. Detailed explanations of the mechanisms involved, as they are eventually deciphered, may differ from the present understanding but this should not diminish the scope or importance of the invention.

While the prototype machine includes tow substantially closed containment vessels, other embodiments could include one containment vessel, or could include three, four, or many more containment vessels. In addition, while the reactors of the prototype machine are about a meter or two in height and diameter and are not pressurized, pressurized reactors may be substantially smaller. For example, it is estimated that a reactor substantially less than a meter in height and diameter, and pressurized to five atmospheres, might generate a five megawall (5 MW) thermal output. Alternatively, much larger containment vessels may be constructed to create reactors with much higher ratings, such as 1000 MW.

In addition, reactors that do not include substantially closed containment vessels may be appropriate for different applications. For example, a cylindrical or converging cylindrical vessel open at one or both ends may be appropriate for propulsion reactors. Such a vessel is also referred to herein as a reactor vessel having an open structure geometry.

In addition, a mechanical containment vessel may not be required for some applications. For example, it may be feasible to contain the plasma with a magnetic or electric field, an inertial containment system, or a combination of these and other techniques. In other alternatives, plasma ionization and heating methods other than a laser beam may also be employed. Examples here may include microwave, electron or ion beams.

It will also be appreciated that the specific configuration of the embodiments described below includes merely illustrative examples of the technology, and that virtually all of the design parameters and choices may be varied somewhat within the scope of the present invention. For example, the size and number of the containment vessels; the size, number, and location of the fuel injectors; the size, number, and location of the vortex injectors; the mixture and volume of the combustion fuels; the mixture and volume of the cooling gas; the pressure of the containment vessels; the type of cooling system, the components of the exhaust processing system; the size, number, and locations of combustion zones; the high voltage magnitude; the power, number, and angle of incidence of the electromagnetic radiation, such as the laser beams; and many other design parameters and choices may be varied somewhat within the scope of the present invention. It may also be discovered that one or more of these features may be omitted or replaced with another structure that performs a similar function. For example, the fuel combustion which generates the initial heating of the reactor may be replaced by an external heat generator, or the nuclear fuels may be injected with appropriate carrying gas or solvent such as air and water. In addition, many alternative fuels may be burned in the reactor, and various types of cooling systems, such as forced air, pressurized water, steam, liquid nitrogen, or others may be embedded in the walls of the reactor, wrapped around the walls of the reactor, or passed through the reaction chambers.

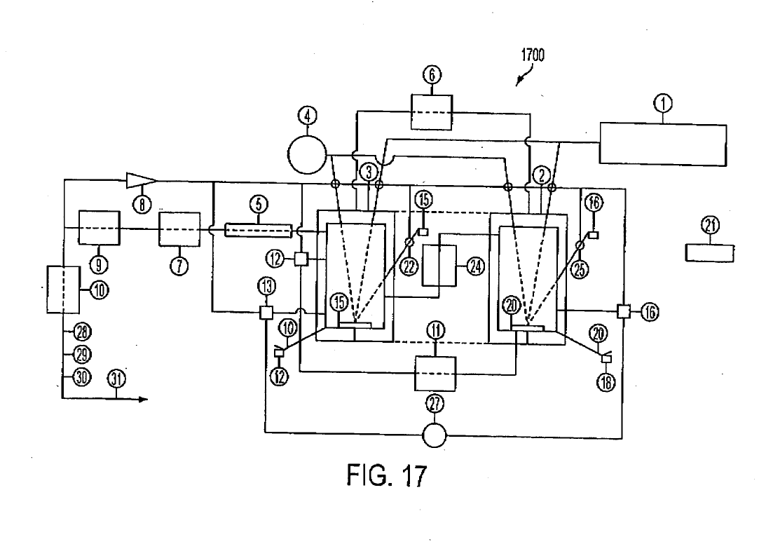

Turning now to the figures, in which like numerals indicate like elements throughout the several figures (except FIG. 17, which has its own numbering system to avoid clutter in the figure), the prototype machine and certain variations of this embodiment will be described in detail. FIG. 1 is a diagram illustrating the basic configuration of a laser-activated laser-initiated plasma reactor 10, which includes a single reaction chamber 11 and some additional equipment. For example, the chamber 11 may have the same configuration as the chambers of the two-chamber prototype machine shown in FIG. 18. These outside dimensions are about 44 inches (106 cm) tall and 28 inches (71 cm) in diameter. The chamber 11 includes a cylindrical outer wall 12, which is typically constructed from one-quarter inch (10 mm) stainless steel. The chamber 11 also includes an inner lining 14, which is typically constructed from alumina (Al₂O₃) containing approximately 1.5-2reactor borate. The lining serves as a heat shield and houses a pressurized-water cooling system 16 that removes heat from the reactor. Other lining materials may be used.

The reactor 10 also includes a system of fuel injectors 18, represented by the fuel injectors 18a and 18b, and a gas vortex injector system 20, represented by the illustrated gas vortex injector. These injectors are housed in conduits embedded in the lining 14. The chamber 11 also includes a laser beam 22 directed through a window 24 into the chamber 11 and pointed at a crystal matrix 26 located in the bottom center of the chamber lining 14. A 12-kV DC voltage source is connected with its negative terminal embedded in a center crystal 25 of the crystal matrix 26, and its positive terminal connected to a conductive element of one of the fuel injectors 18a. A recirculation conduit 30 can be included which circulates exhaust from an outlet port 32 to an inlet port 34 of the chamber 12. A +10 kV/−10 kV ionizer 36 can be used to excite the recirculated exhaust before it is reintroduced into the chamber 11. In addition, a portion of the exhaust is diverted to an exhaust processing system 38, which cleanses the exhaust and eventually vents it to the atmosphere. There are also numerous temperature and pressure sensors and one or more observation ports installed in the chamber 11. Additional devices, such as magnetic field sensors, helium detectors, radiation sources and detectors, cooling liquid injectors, auxiliary laser beam conduits, and other instruments for analyzing and controlling the reaction may also be installed in the lining 14.

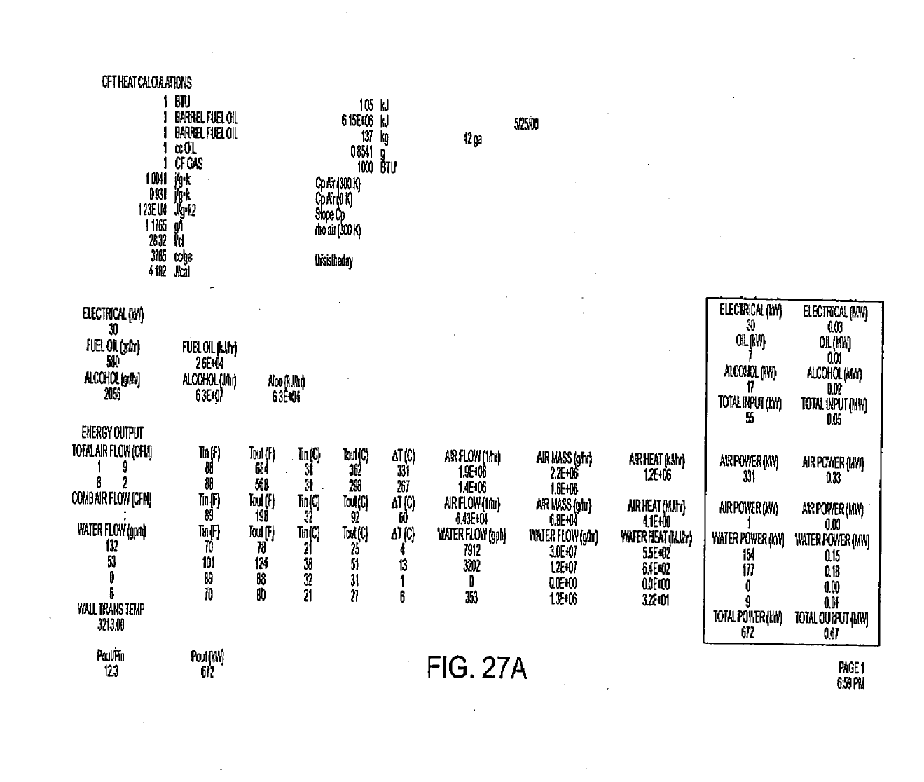

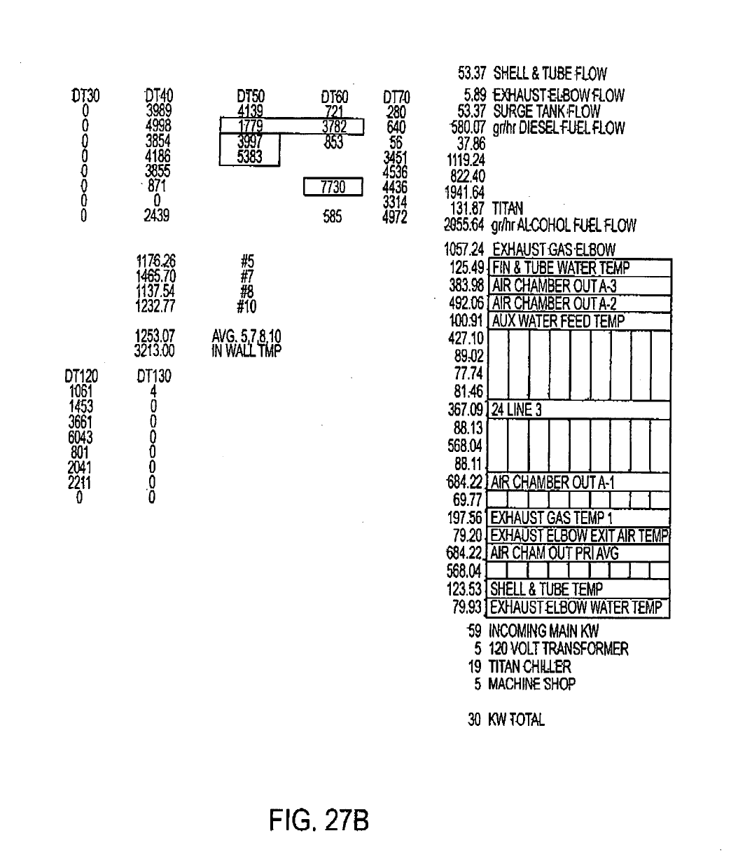

A hot gas mass 40 is created by injecting a combustion fuel 42, typically diesel fuel mixed with ethyl alcohol and/or water, into a combustion zone located near the bottom of the inner lining 14 of the chamber 11. The flow rates for the fuel are given in FIG. 27A. The vortex gas flow rate can be varied significantly and still achieve operation. The combustion fuel 42 is atomized with ambient air, oxygen, natural gas, and/or other gasses or liquids, and can also be atomized with recirculation exhaust. The atomized combustion fuel 42 is injected into the chamber 11 with sufficient force to allow it to form the hot gas mass 40 as it burns within the combustion zone. For example, the combustion fuel 42 may be injected into the chamber 11 at 10 to 120 psi. In particular, a relatively low-pressure fuel injection, such as 10 to 20 psi, may be used until the wall reaches an intermediate temperature of about 1800° F. A higher-pressure fuel injection, such as 120 psi, may more effectively force the fuel into the hot gas mass. The large DC voltage gradient across the combustion zone created by the voltage source 28 ionizes the hot gases. A cooling gas 44, typically oxygen mixed with any of or a combination of recirculated exhaust, ambient air, and/or other gases, is injected into the chamber 11 to form a rotating gas vortex between the lining wall 14 and the hot gas mass 40. The cooling gas should be injected into the chamber 11 with sufficient force to form a vortex around the hot gas or plasma 40 and to prevent the hot gas or plasma from contacting the inner lining 14. The toroidal or quasi-spherical plasma mass 40, which remains suspended just above the crystal matrix 26, is seen to range in size from about one-half inch (20 mm) to about six inches (226 mm) in height and diameter in the prototype machine.

The reaction chamber 11 is typically constructed by first assembling the chamber wall 12, and then fixing the internal parts into place. The top portion of the chamber 11 may be a removable lid to allow access to the interior of the chamber. To facilitate holding the lining 14 in place, a system of angle supports 46 is welded around the inner surface of the chamber wall 12. These supports may extend outside the chamber wall 12 to form cooling fins. For example, this configuration has been found suitable for the air-cooled prototype machine shown in FIG. 18.

The internal parts are fastened to the supports 46 and the chamber wall 12 to hold them in place. These internal parts typically include conduits for the cooling system 16, conduits for the fuel injectors 18, conduits for the air injectors 20, the recirculation conduits 30, the window 24 and a conduit for the laser beam, windows and conduits for observation ports, electric leads for the DC power source 28, and conduits or leads for the various temperature and pressure sensors and other devices. In addition to these components, a form is secured in the center of the chamber 11 to create the contour of the inner lining 14. A slurry containing the ceramic lining material mixed with water is then poured like concrete into the chamber 11 between the chamber wall 12 and the form. The slurry dries within a few days and cures to a hardened state when heated.

FIG. 2 is a diagram illustrating the interaction of the laser within the laser-initiated plasma reactor 10. As noted above, the toroidal plasma mass 40 remains suspended just above the crystal matrix 26, which is partially embedded within a base 58 constructed of the same material as the lining 14. The laser beam 22 is directed through the plasma and trained directly on the center crystal 25 of the crystal matrix 16. The large DC voltage is imposed by the power source 28 across the combustion zone at the bottom section of the chamber 11.

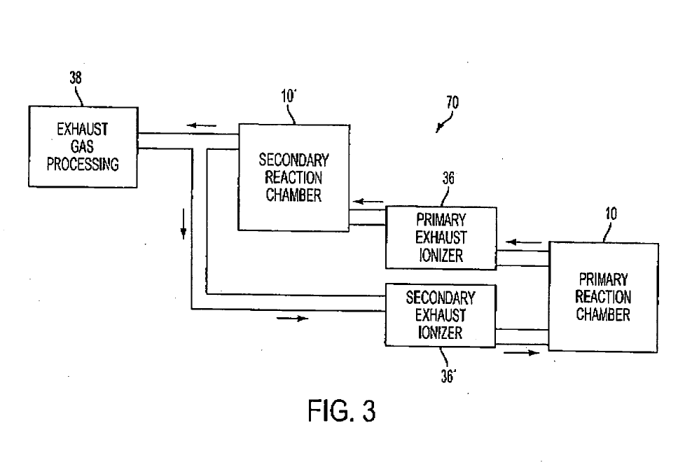

FIG. 3 is a block diagram illustrating exhaust recirculation in a laser-initiated plasma reactor 70 including two substantially closed reactors 10 and 10′. This configuration corresponds to the prototype machine, in which each reactor has the configuration of the reactor 10 described with reference to FIG. 1. In this machine, a primary exhaust ionizer 36 excites exhaust circulated from the primary reactor 10 to the secondary reactor 10′. Similarly, a secondary exhaust ionizer 36′ excites exhaust circulated from the secondary reactor 10′ to the primary reactor 10. This particular embodiment includes a single exhaust processing system 38, which cleans the exhaust before venting them to the atmosphere.

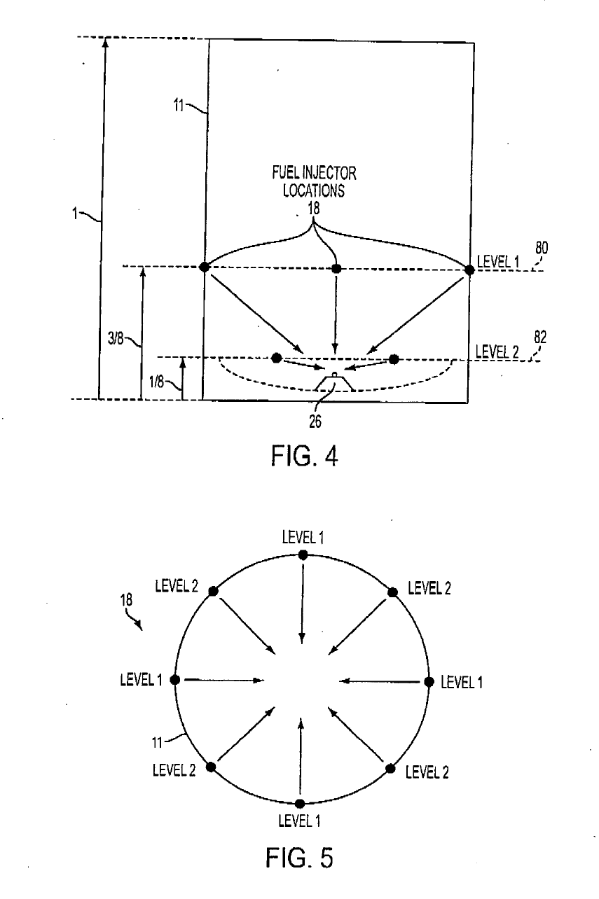

FIG. 4 is a side view of the reactor 10 illustrating the location of the fuel injectors 18. The reactor 10 includes a first substantially horizontal tier 80 of four fuel injectors (level 1) and a second substantially horizontal tier 82 of four fuel injectors (level 2). The four injectors of each tier are spaced evenly around the perimeter of the chamber 11. That is, the four fuel injectors of each tier are positioned in approximately 90° increments around the perimeter of the chamber 11. In addition, the fuel injectors of the first tier 80 are offset by approximately 45° from the injectors of the second tier 82. The first tier of injectors 80 is positioned at a level approximately three-eighths (⅜) of the chamber height from the bottom of the chamber. The second tier of injectors 82 is positioned at a level approximately one-eights (⅛) of the chamber height from the bottom of the chamber. From the side view, each fuel injector is directed slightly downward toward a common focal point just above the crystal matrix 26 located at the bottom center of the lining 14. Thus, the injectors of the upper first tier 80 are directed more steeply downward than the injectors of the lower second tier 82. A relatively low pressure on the fuel passing through the injectors 18, such as 10 to 20 psi, may be used until the wall reaches an intermediate temperature of about 1800° F. A higher-pressure fuel injection may more effectively force the fuel into the plasma, which allows the plasma to reach higher temperatures. In particular, it has been found that increasing the pressure on the fuel injectors 18 of the upper level 80 to about 120 psi effectively forces the fuel into the plasma once the plasma becomes super heated. It will be appreciated that the effective fuel injection pressure may vary for other reactor configurations. For example, a higher-pressure fuel injection may be effective for a relatively high pressure or large volume reactor, and a lower-pressure fuel injection may be effective for lower pressure or smaller volume models. Similarly, a higher-pressure fuel injection may be effective for propulsion units in which a relatively large mass of cooling fluid or gas in passing through the reactor. The specific operational parameters for a wide range of reactor applications will become apparent to those who are, or will become, skilled in the art of reactor design.

FIG. 5 is a top view of the reactor 10 illustrating the location of the fuel injectors 18. The injectors 18 are positioned in approximately 45° increments around the perimeter of the chamber 11, with the injectors of each tier alternating around the perimeter. From the top view, each fuel injector is directed toward the center of the chamber 11.

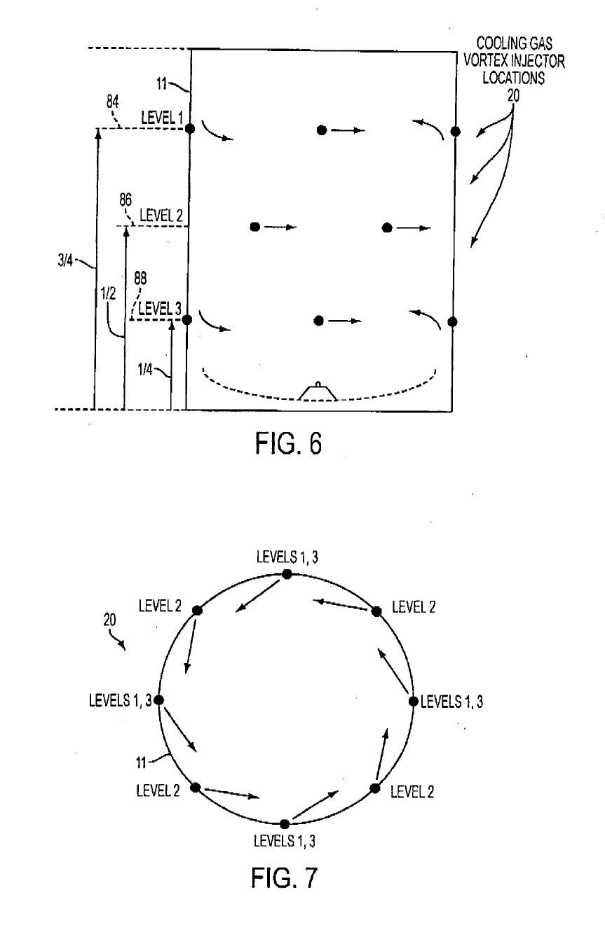

FIG. 6 is a side view of the reactor 10 illustrating the location of the gas vortex injectors 20. The reactor 10 includes a first substantially horizontal tier 84 of four vortex injectors (level 1), a second substantially horizontal tier 86 of four vortex injectors (level 2), and a third substantially horizontal tier 88 of four vortex injectors (level 3). The four injectors of each tier are space apart evenly around the perimeter of the chamber 11. That is, the four vortex injectors of each tier are positioned in approximately 90° increments around the perimeter of the chamber 11. In addition, the vortex injectors of the first tier 84 are offset by approximately 45° from the injectors of the second tier 86, and the injectors of the first tier 84 are rotationally aligned with the injectors of the third tier 88. The first tier 84 is positioned at a level approximately three-quarters (¾) of the chamber height from the bottom of the chamber, the second tier 84 is positioned at a level approximately one half (½) of the chamber height from the bottom of the chamber, and the third tier 88 is positioned at a level approximately one quarter (¼) of the chamber height from the bottom of the chamber. From the side view, each vortex injector is directed horizontally from left to right to create a counterclockwise vortex of gas within the chamber 11. The vortex injectors lower third tier 88 could be directed slightly downward to help get the gas around the underside of the plasma 40.

FIG. 7 is a top view of the reactor 10 illustrating the location of the gas vortex injectors 20. The injectors 20 are positioned in approximately 45° increments around the perimeter of the chamber 11, with the injectors of the upper and lower tiers 84 and 86 (levels 1 and 3) aligned with each other and alternating around the perimeter with the injectors of the middle tier 86 (level 2). From the top view, each vortex injector is directed in a substantially tangential orientation from left to right with respect to an inward radial orientation to create a counterclockwise vortex of gas within the chamber 11.

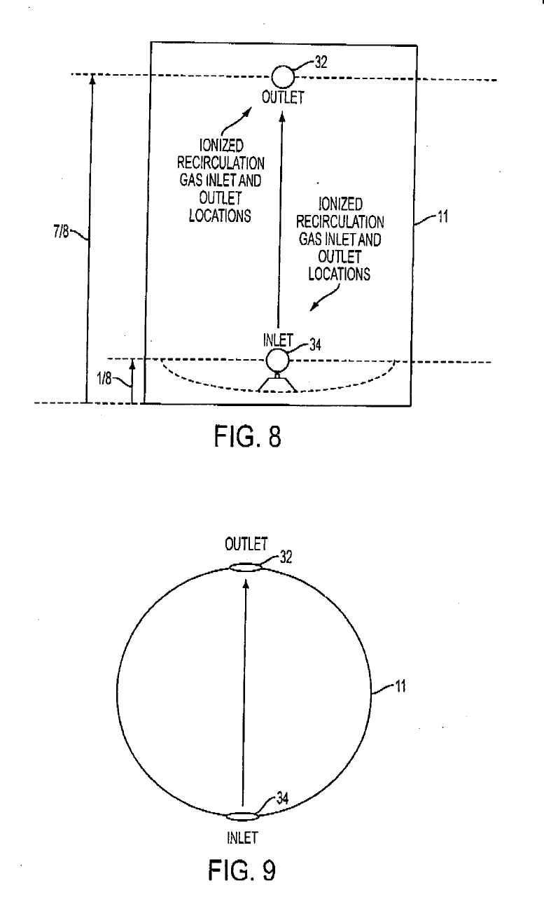

FIG. 8 is a side view of the reactor 10 illustrating the location of the recirculation outlet and inlet air ports 32 and 34. Each port may be approximately 4 inches (10 cm) in diameter, and the airflow through each port typically varies between 10 cfm and 750 cfm. The outlet 32 is positioned at a level approximately seven-eighths (⅞) of the chamber height from the bottom of the chamber, and the inlet 34 is positioned at a level approximately one-eighth (⅛) of the chamber height of the bottom of the chamber.

FIG. 9 is a top view of the reactor 10 illustrating the location of the recirculation outlet air port 32 and the inset ar port 34. From the top view, these ports are located on opposite sides of the chamber 11. That is, the outlet air port 32 and the inlet air port 34 are spaced approximately 180° apart.

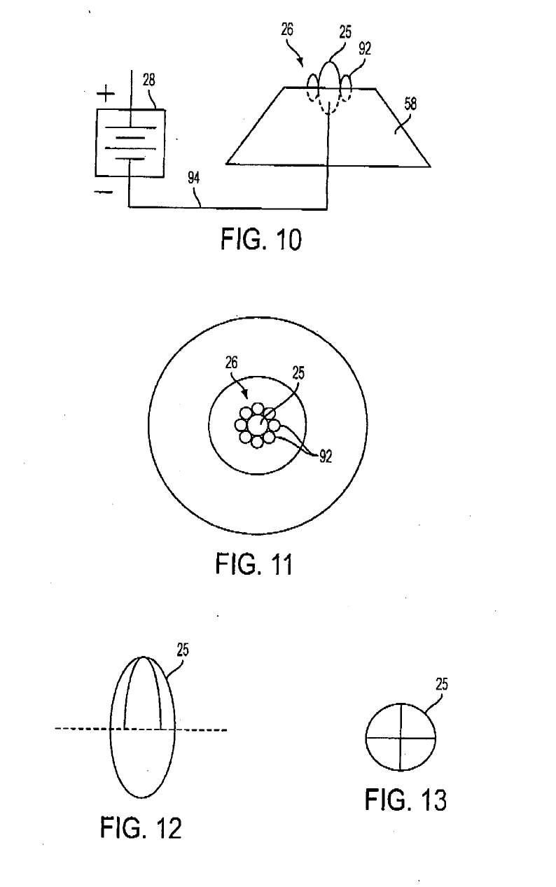

FIG. 10 is a side view of the crystal matrix 26, which is located at the bottom center of the lining 14 of the chamber 11. Each crystal of the matrix 26 is oblong and embedded about half way up its longer dimension within a base 58 constructed of the same material as the lining 14. Each crystal is roughly cut into an octahedron crystal of alumina (such as corundum crystal). The center crystal 25 is approximately two inches (5 cm) tall and one inch (2.5 cm) across. The dimensions of the smaller crystals 92 are approximately half those of the center crystal 25. A negative lead 94 from the power source 28, which is constructed from a ⅜ inch (1 cm) conducting rod, threads into a threaded channel in the bottom of the center crystal 25. The entire base 58, which the embedded crystal matrix 26, may be screwed on and off the lead 94. Thus, the crystal matrix 26 may be removed from the reactor 10 and replaced from time to time.

FIG. 11 is a top view of the crystal matrix 26, which includes one larger center crystal 25 surrounded by eight smaller crystals 92 that are spaced around the perimeter of the center crystal. Each smaller crystal 92 is typically positioned so that it is in physical contact with the center crystal 25 and a smaller crystal 92 on either side.

FIG. 12 is a side view of the center crystal 25, which illustrates that it is shaped roughly into an octahedron. FIG. 13 is a top view of the same crystal. The smaller crystals 92 are similarly shaped roughly into octahedrons.

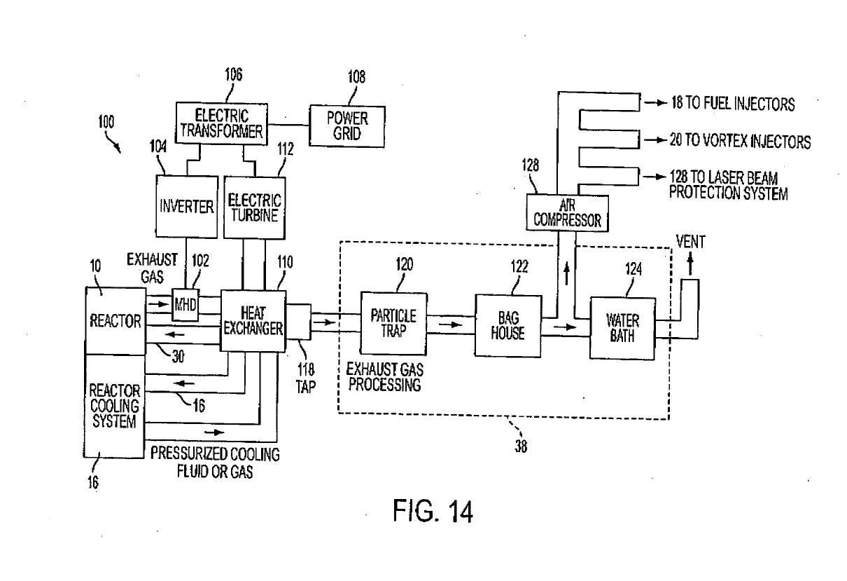

FIG. 14 is a block diagram of a reactor system 100 including electric generation equipment, exhaust processing equipment, and air handling equipment. The reactor system 100 included one or more reactors 10, as described above.

The exhaust may be seed to a beat exchanger 110 that exacts heat via a working fluid from the exhaust to drive an electric turbine/generator set 112. The output from the electric turbine/generator set 112 may then be applied to a transformer, which is represented by the transformer 106.

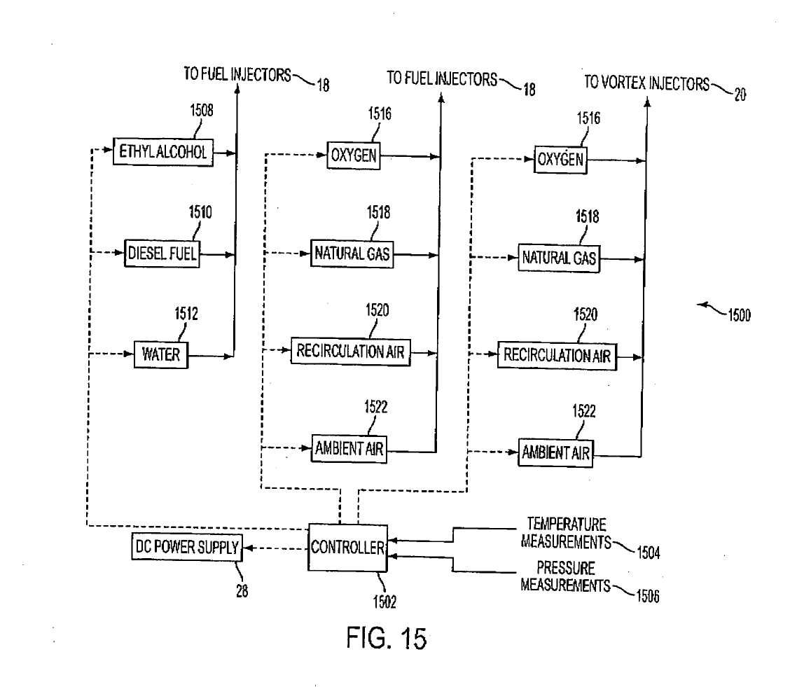

FIG. 15 is a block diagram of an instrumentation and control system 1500 for a laser-initiated plasma reactor. The control system 1500 includes a computer or manually operated controller 1502, which receives instrumentation inputs including temperature measurements 1504 and pressure measurements 1506 from various sensor locators in the reactor system. The controller 1502 may also receive other instrumentation inputs, such as magnetic field measurements, helium detection, and any other inputs that may be desirable for monitoring and controlling the reactor. The controller 1502 uses these inputs to drive the controlled devices of the reactor to obtain a desired operational state. For example, the controller 1502 may drive the DC power supply 28 to vary its output by pulsing the supply to obtain an AC or quasi-AC voltage.

The controller 1502 may also control the volume and mixture of the fuels and other materials supplied to the reactor. For example, the controller 1502 may control the delivery of fuel to the fuel injectors 18 from a supply of ethyl alcohol 1508, a supply of diesel fuel 1510, and/or a supply of water 1152. The controller 1502 may also control the delivery of an atomizing gas to the fuel injectors 18 from a supply of oxygen 1516, a supply of natural gas 1518, a supply of recirculated air 1520, and/or a supply of ambient air 1522. Similarly, the controller 1502 may control the delivery of a gas to the vortex injectors 20 from the supply of oxygen 1516, the supply of natural gas 1518, the supply of recirculation air 1520, and/or the supply of ambient air 1522. For example, the following mixture and delivery volumes have produced a controlled, steady-state fusion reaction in the prototype machine one the wall of the machine was brought up to the critical temperature (about 4000° F.) required to initiate the fusion reaction (D=diesel, B=ethyl alcohol, W=water, N=natural gas, O=Oxygen, and A=ambient air; all shown in percent by weight):

| | Mixture | Volume | |
|---|---|---|---|
| Combustion Fuel: | 85% D + 10% E + 5% W | 1.5 to 3 | l/hr |
| Atomizing Gas: | 20% O + 80% A | 50 to 200 | scfhr |
| Vortex Gas: | 40% O + 60% A | 50 to 250 | scfhr |

It should be understood that these mixtures are varied, and that natural gas may be used in the mixtures as the reactor is brought up the critical temperature. In addition, the controller 1502 may control the introduction of other materials into the reactor, such as waste material, a binding agent, and other substrates. Also, those skilled in the art will appreciate that other fuels and substances may be used in the reactor.

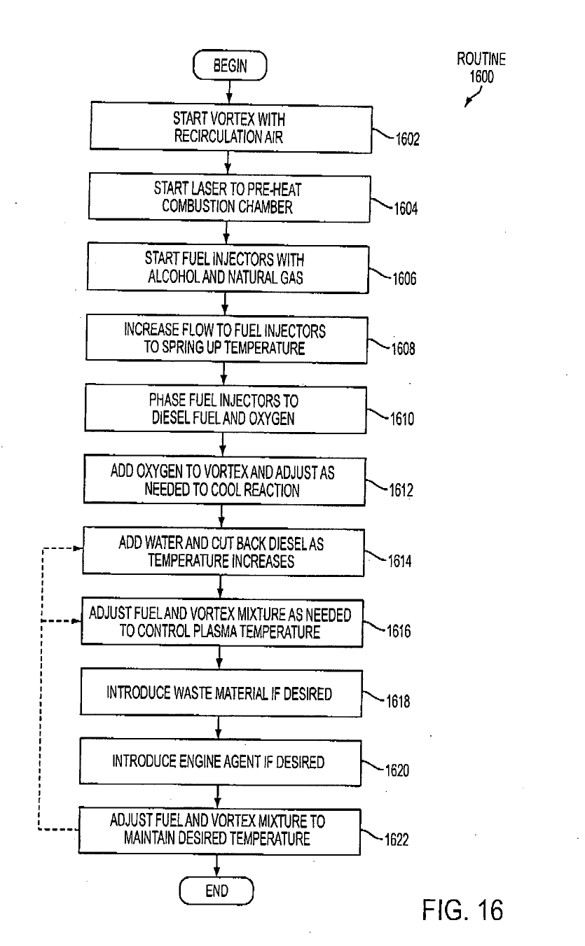

FIG. 16 is a logic flow diagram illustrating a routine 1600 for operating the laser-initiated plasma reactor 10. Basically, this routine describes an approach for forming plasma in a cold reactor and bringing the rector up to and above the critical temperature at which the reactor attains a controlled, steady-state reaction. During this description, the elements shown on FIG. 1 will also be referenced. For the prototype machine, this process is performed manually. However, the process may be automated or partially automated for commercial embodiments of the technology.

Prior to routine 1600, the laser should be warmed up, the air compressor and power supplies should be turned on. In stp 1602, air is supplied to the vortex injectors 20. Step 1602 is followed by step 1604, in which the laser beam 22 is activated. This condition continues for 30 to 45 minutes or so to pre-heat the reaction chamber 11. Step 1604 is followed by step 1606, in which the fuel injectors are supplied with ethyl alcohol atomized with a mixture of air, oxygen and natural gas, or possibly recirculated air. If the reaction chamber 11 has been properly pre-heated, the alcohol and natural gas will ignite in the combustion zone to begin the formation of the combustion plasma mass 40. Step 1606 is followed by step 1608, in which the fuel injector supply is increased to increase the size and temperature of the hot gas mass 40.

Step 1608 is followed by step 1600, in which the fuel injector supply is phased over to diesel fuel. Step 1610 is followed by step 1612, in which oxygen is added to the cooling gas to prevent overheating of the lining 14. Step 1612 is followed by step 1614, in which water is added to the fuel supply, and the supply of diesel fuel may be cut back. This further increases the size and temperature of the reaction, and may be accompanied by an increase in the volume and oxygen content of the cooling gas. In step 1614 the fuel injector and cooling gas mixtures may be further adjusted to bring the reaction up to and above the critical temperature. In particular, it has been found that increasing the pressure on the fuel injectors of the upper level 80 to about 120 psi may effectively allow the temperature of the plasma to continue increasing. Step 1614 is followed by step 1616, in which the fuel injector and cooling gas mixtures are adjusted to maintain a controlled, steady-state reaction within the plasma 40.

FIG. 17 is a schematic block diagram illustrating one possible configuration for a two-chamber combustion plasma nuclear fusion 1700. All of the element numerals shown on FIG. 17 should be preceded by the designation “17-” which is not shown to avoid cluttering the diagram. The reactor 1700 includes a laser 17-1, such as a 3.25-kW CO₂ laser, which produces a laser beam that is split and directed into a primary reaction chamber 17-2 and a secondary reaction chamber 17-3. A liquid fuel system 17-4 supplies a combustion feel to the reactors through fuel injectors (not shown) that include atomizers 17-16. A heat exchanger 17-6 extracts heat from exhaust removed from the secondary reaction chamber 17-2.

From the heat exchanger 17-6, the exhaust passes through a particle trap 17-7 and a bag-house filtration system 17-8. A portion of the exhaust can be passed to an air compressor 17-9 to be recirculated for subsequent use in the reactor 1700. The remaining exhaust is passed through a water bath scrubber 17-9 and vented to the atmosphere. A carbon monoxide monitor 17-8, a carbon dioxide monitor 17-29, and a helium detector 17-30 and other gas monitors are typically located in the vent conduit to monitor these constituents of the exhaust before they are released to the atmosphere. Any recirculated exhaust can be excited by an ionizer 17-11 before reintroduction into the primary reaction chamber 17-2. In addition, before ionization a portion of the recirculated exhaust may be extracted by venturi-assist taps 17-12 and 17-14 for supply to the vortex injectors in the secondary and primary reaction chambers, 17-3 and 17-2, respectively. An oxygen supply 17-27 and recirculated exhaust and/or air flow the air compressor 17-9 can also supply the vortex injectors in the secondary and primary reaction chambers, 17-13 and 17-14, respectively.

The secondary reaction chamber 17-3 includes a drain 17-19, and the primary reaction chamber 17-2 includes a drain 17-20. These drains terminate in a drain relief valve 17-17. Each reaction chamber 17-2, 17-3 also includes an air curtain beam protection system 17-21 where the laser beam enters the chamber. Similar air curtains 17-22, 17-23 also protect the entry ports for the secondary and primary pyrometers. The air supply conduits for these air curtain systems terminate in a relief valve 17-15. A primary crystal matrix 17-26 is located in the bottom center of the primary reaction chamber 17-2, and a secondary crystal matrix 17-25 is located in the bottom center of the secondary reaction chamber 17-3. An ionizer 17-24 may excite exhaust circulated from the primary reaction chamber 17-2 to the secondary reaction clamber 17-3. Each reaction chamber also includes a pressurized water cooling system (not shown). In addition, a variety of instruments (not shown) provide measurements to a control panel (not shown).

FIGS. 18-26 are engineering drawings for constructed or planned reactor configurations. In these illustrations all dimensions are shown in inches. FIG. 18 is a front side view of a two-reactor prototype machine 1800 that has been constructed and tested at length to demonstrate the operation of the combustion plasma nuclear fusion reactor. The prototype machine includes two, cylindrical reactors, 10 and 10′, each about 44 inches (106 cm) tall and 28 inches (71 cm) in diameter. This reactor configuration is similar to that described with reference to FIGS. 1-17, except that the pressurized-water cooling system 16 has been replaced by a forced-air cooling system 90. A pressurized-water, pressurized-gas, mixed-phase, or liquid nitrogen cooling system 16 may be preferred for a commercial embodiment because it is more conducive to generating electricity from the cooling substance. However, the prototype machine 1800 was constructed with the forced-air cooling system 90 to reduce the capital cost of the unit. The forced-air cooling system 90 includes an air jacket that surrounds each reactor vessel and two fans driven by 2, 7.5-hp electric motors. Except for the cooling system, the prototype machine may be constructed and operated in the manner described above with reference to FIGS. 1-17.

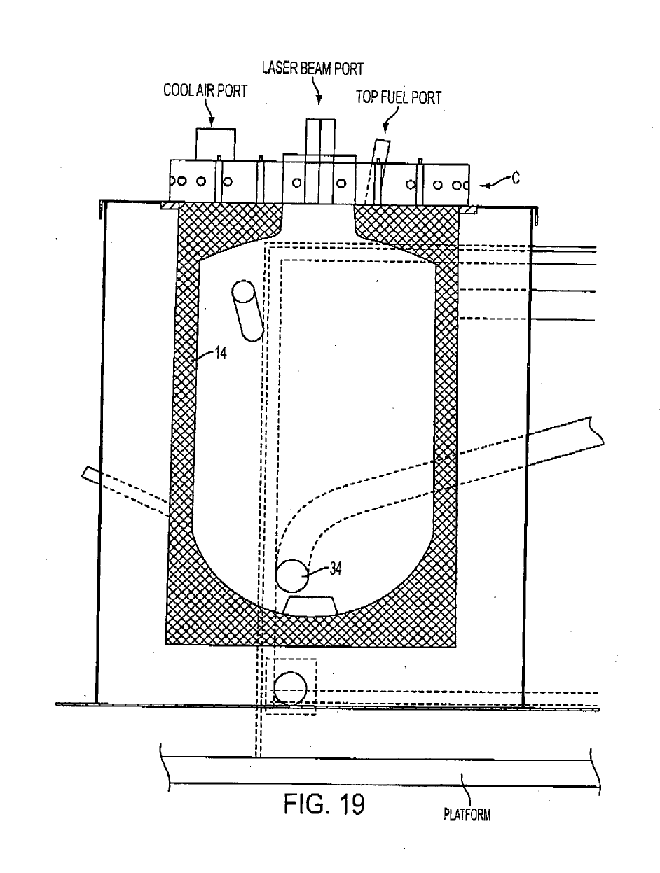

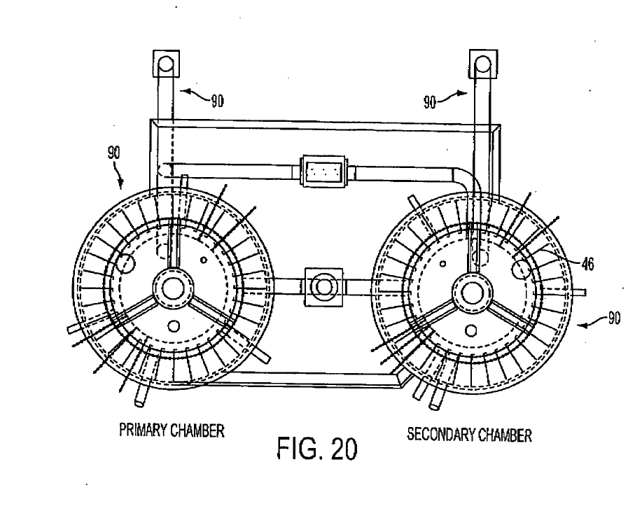

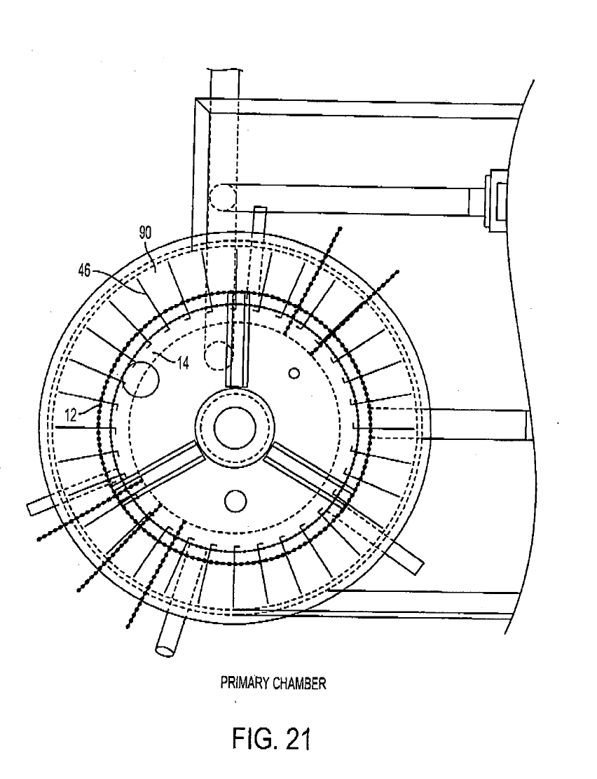

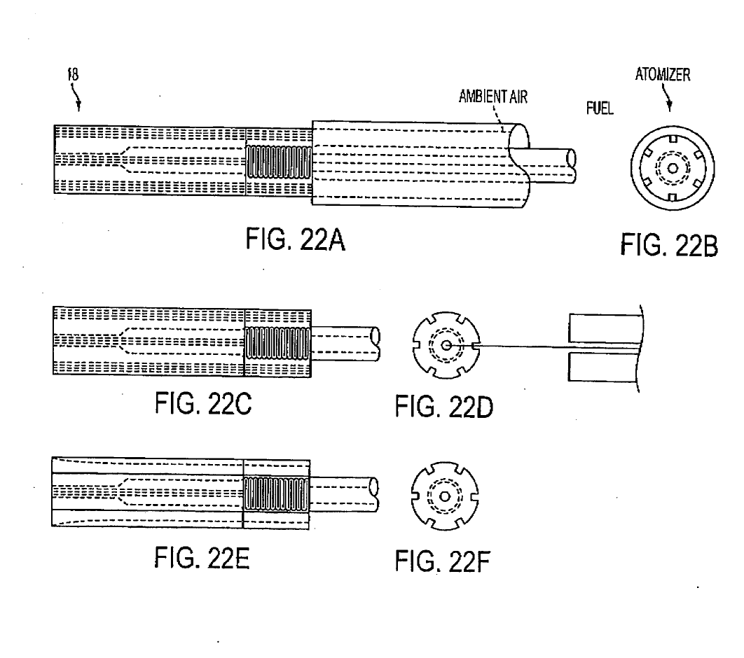

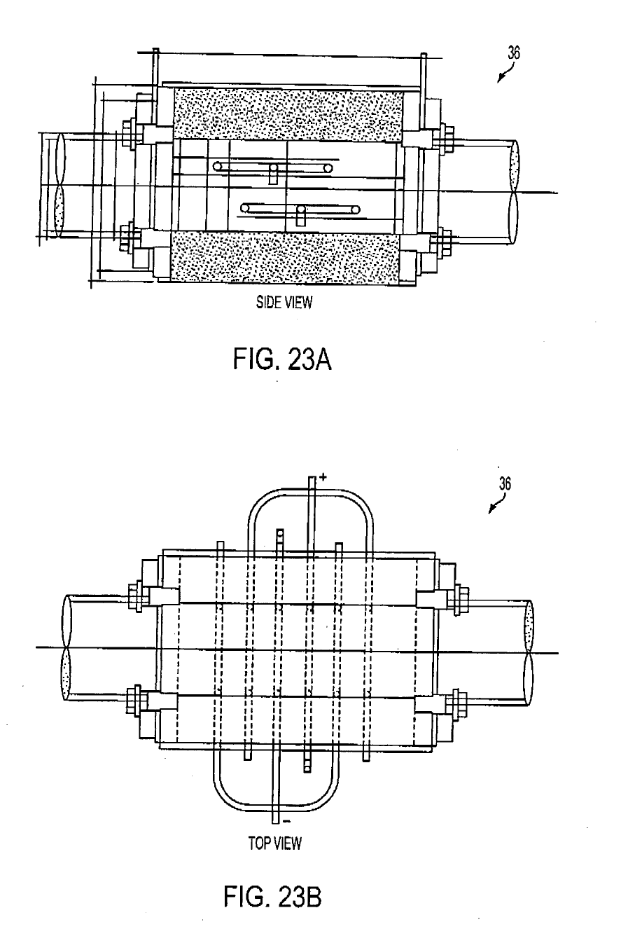

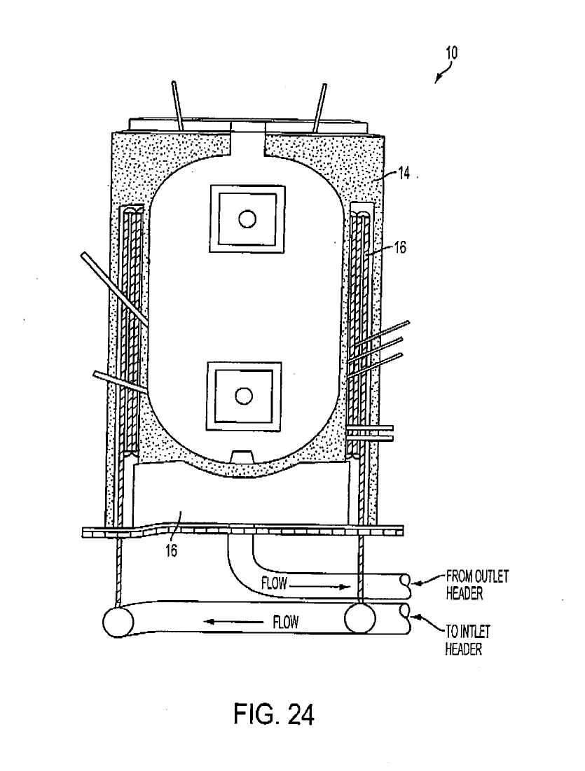

FIG. 19 is a front side view of one reactor 10 of the prototype machine 1800. This enlarged view shows the dimensions and configuration more clearly. FIG. 20 is a top view of the reactors of the prototype machine 1800, which also illustrates the forced-air cooling system 90, which forces air into an air jacket surrounding the reactor. FIG. 21 is an enlarged top view of the prototype machine 1800 illustrating internal components of the reactors, including the number and configuration of the support members 46. In this air-cooled embodiment, these supports form cooling fins that extend into the air jacket of the forced-air cooling system 90. FIGS. 22a-f illustrate the configuration of the fuel injectors 18. FIGS. 23A and 24B illustrate the configuration of the ionizers 36a and 36b of he prototype machine 1800. FIG. 23B is a top view of the embodiment of the reactor design illustrated in FIG. 23A.

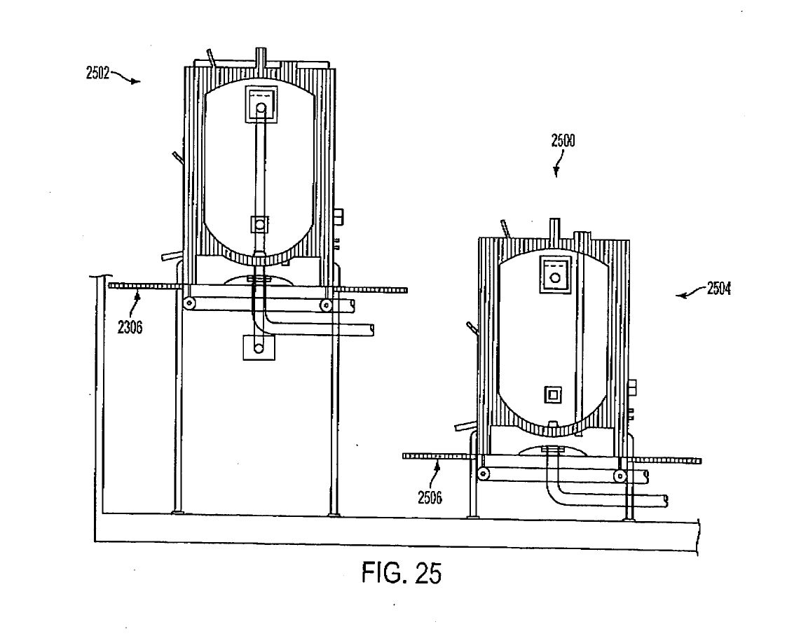

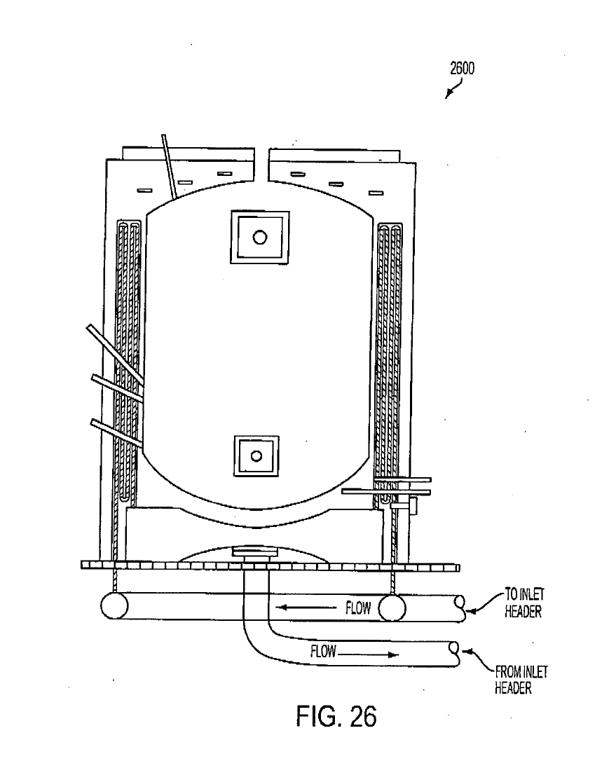

FIG. 24 is a front side view of an alternative design for the reactor 10 including a pressurized-water cooling system 16 embedded in the walls of the reactor. FIG. 25 illustrates an alternative configuration for a two-reactor laser-initiated plasma reactor 2500 including a pressurized-water cooling system. This embodiment includes two cylindrical reactors, 2502 and 2504, each about 93 inches (236 cm) tall (measured from the platform 2506) and 69 inches (175 cm) in diameter. These alternative embodiments may also be constructed and operated in the manner described above with reference to FIGS. 1-17. FIG. 26 is a front side view of one reactor of the alternative two-reactor laser-initiated plasma reactor 2600 illustrating the cooling system embedded in the walls and other features of the reactor.

FIGS. 27A-B include a table summarizing results obtained from an energy balance test conducted for the prototype machine 1800 shown in FIG. 18. These results show that, at the time the energy balance test was conducted, the machine was producing 627 kW, which was 12.3 times the energy that could be attributed to conventional combustion of the fuel present in the reactor. These surprising results lead to the determination that nuclear fusion might be occurring within the machine. An exhaust analysis was then conducted to confirm whether nuclear fusion byproducts, such as He⁴, were present in the exhaust.

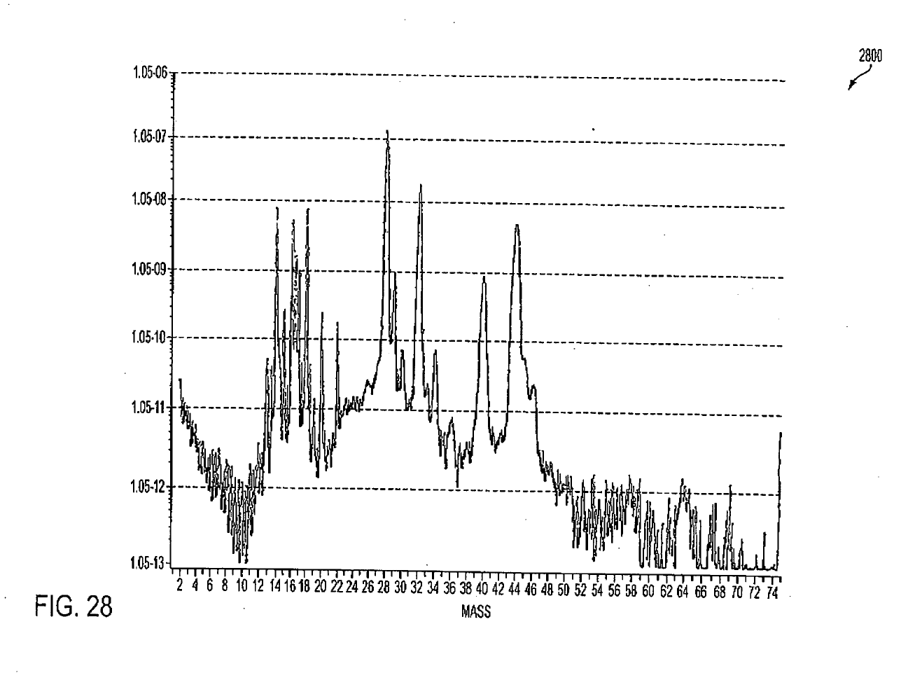

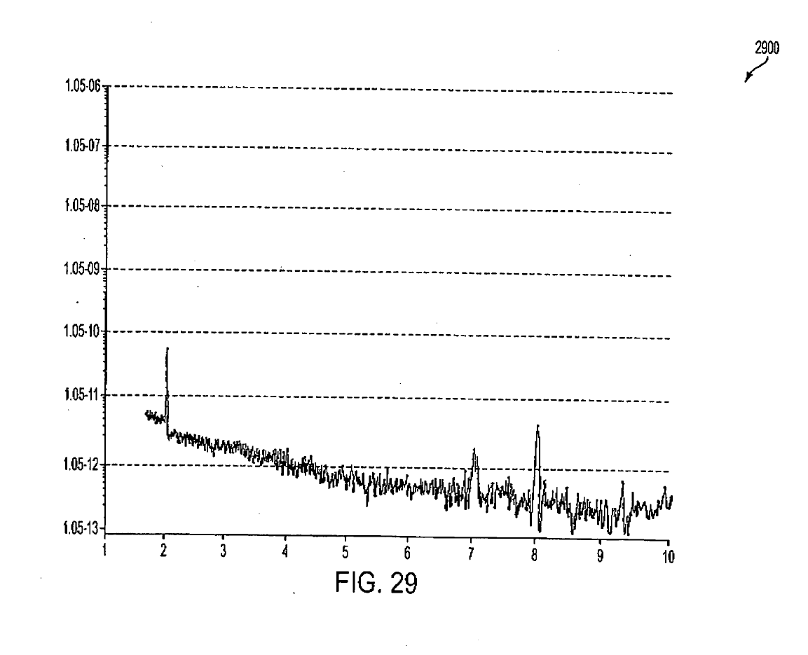

FIG. 28 is a chart containing an atomic mass-to-charge spectrum analysis 2800 conducted for exhaust obtained from the prototype machine. The charts shown in FIGS. 28-32 are similar, and represent the accumulated results for 30-second analyses. Although the portion of the analysis 2800 in the range of He⁴ at the far left of the scale is quite cluttered, it appears that there might be a detectable response for these elements. FIG. 29 is a chart containing a mass-to-large spectrum analysis 2900 for atomic weights one through ten conducted for ambient air near the prototype machine. This chart shows that there was no measurable He⁴ present in the ambient air.

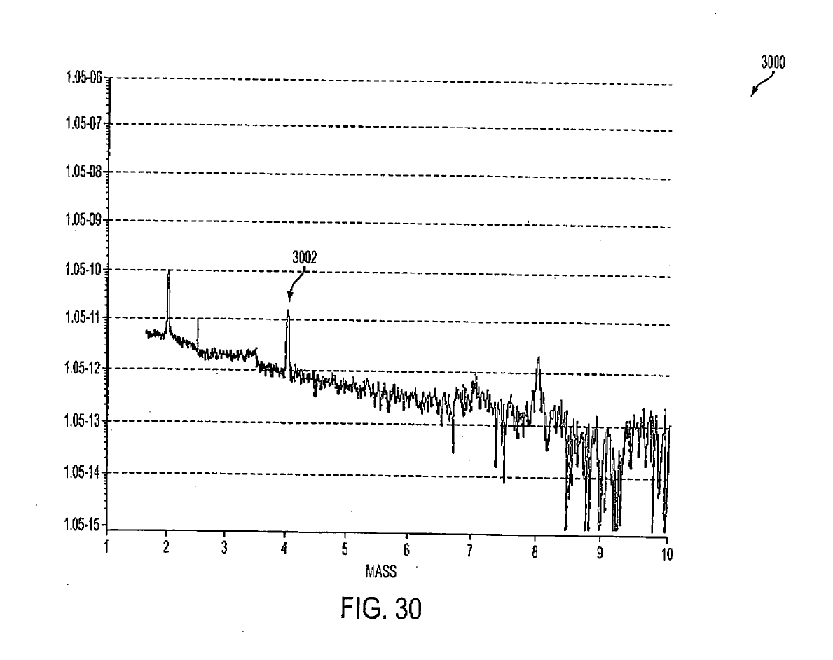

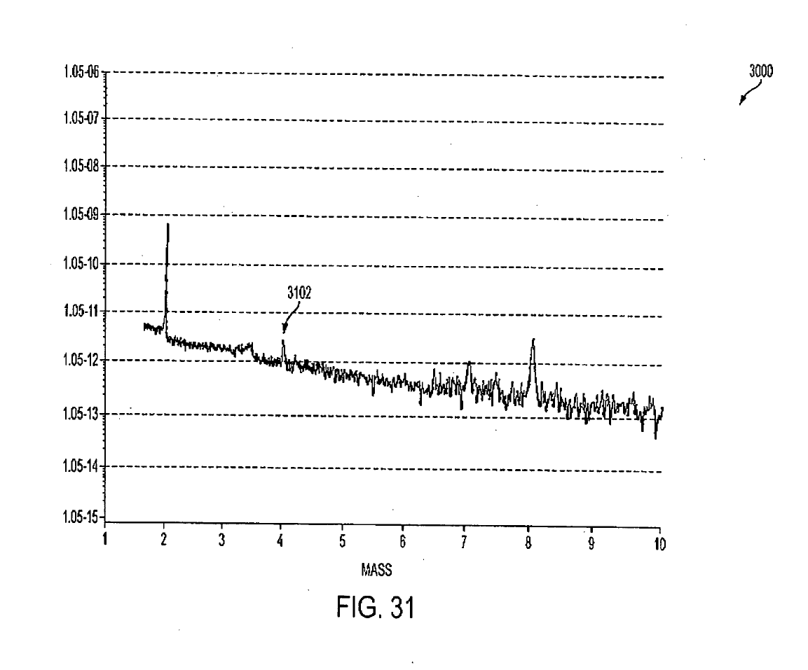

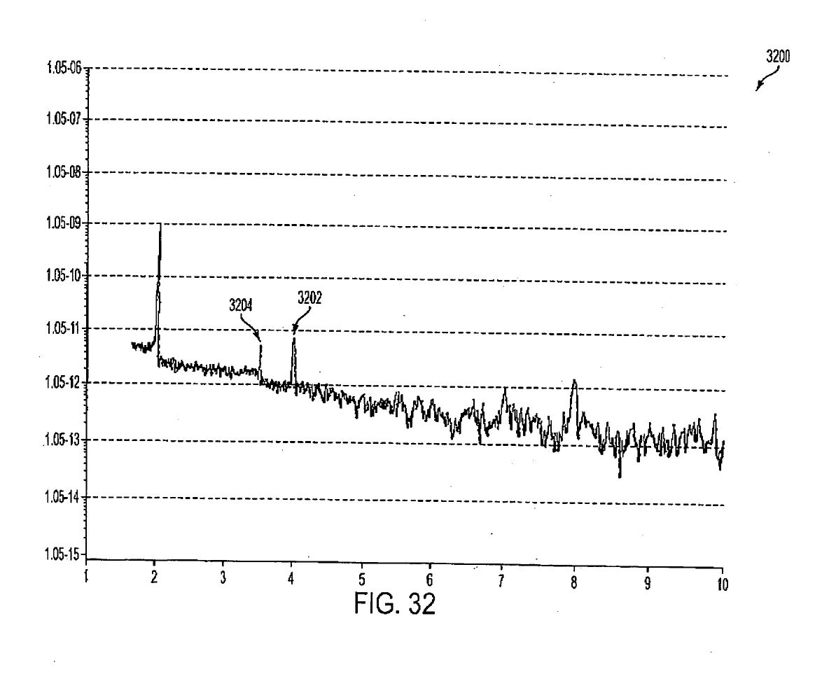

FIG. 30 is a chart containing an atomic mass-to-charge spectrum analysis 3000 for atomic weights one through ten conducted for exhaust obtained from the prototype machine. This analysis was conducted on the same day as the ambient air spectrum analysis 2900 shown in FIG. 29. The spectrum analysis 3000 includes a strong spike 3002 indicating the presence of He⁴ in the exhaust. FIG. 31 is a similar chart for an analysis 3100 conducted about ten minutes after the analysis 3000. In the analysis 3100, the He⁴ spike is significantly smaller than the spike in the analysis 3000. The He⁴ spike produced by the exhaust from the prototype machine was observed to fluctuate in this manner, sometimes reading no detectable He⁴ response, sometimes reading a relatively small He⁴ response as shown in analysis 3100, and occasionally but continually flaring up to a stronger He⁴ response as shown in analysis 3000.

FIG. 32 is a chart an atomic mass-to-charge spectrum analysis 3200 for atomic weights one through ten conducted for exhaust obtained from the prototype machine. This analysis was conducted on the same day as the ambient air spectrum analyses shown to FIG. 29. The spectrum analysis 3200 includes a strong spike 3202 indicating the presence of He⁴.

The invention is further illustrated in the following Example, which should not be regarded as limiting.

### EXAMPLE

A prototype reactor comprised of alumina interior walls with 1.5-2% borate by weight was operated according to the procedure set forth, i.e., a hot gas mass created from the combustion of diesel fuel and ethyl alcohol and raised to the critical temperature by use of a CO₂ laser and a high voltage discharge. Readings were taken over 5 minute increments during the operation of the reactor once the self-sustaining energy reaction had begun in order to calculate the amount of energy produced. The readings included power input, flow rates of fuel, flow rates of cooling gases and liquids, reactor vessel wall temperature, and temperature increase in cooling gases and liquids.

Total electrical power input to the system was measured by way of a power meter, i.e., the electrical power that operated the laser, the high voltage discharge, and all other power-consuming components were run through one electricity meter to provide a reading on the total power input to the reactor. No other power sources were used to input power to the reactor. Over one five-minute interval, the total power input to the reactor was measured to be 30 kW. Next, fuel flow rates were measured during the same five-minute interval to be at the rate of 580 gm/hr of diesel fuel and 2,056 gm/hr of ethyl alcohol. The heat of combustion of this amount of fuel can be determined using methods well known in the art to be approximately 7 kW and 17 kW respectively. Thus, the total amount of power input to the reactor was approximately 54-55 kW, with errors for rounding.

The reactor was cooled with both air and water. Two separate cooling air flows were determined to have temperatures into the reactor cooling coils of 88 degrees F., and temperature out of the reactor cooling coils of 684 degrees F. and 568 degrees F., respectively. Power output as measured by increases in the air temperature was computed by methods well known in the art to be approximately 331 kW. Similarly, combustion air flow was determined to have increased from a temperature in of 89 degrees F. to 198 degrees F., for a power output of approximately 1 kW. Finally, three separate water-cooling flows were measured. Two water flows had temperatures in of 70 degrees F., with output water temperatures of 78 degrees F. and 80 degrees F., respectively. One water flow had a temperature in of 101 degrees F. and a temperature out of 124 degrees F. Power output as measured by increases in the water temperature was computed by methods well known in the art to be approximately 340 kW. Thus, the total power output as determined from the increase in the cooling air and water temperatures was approximately 672 kW. This translates to a ratio of the power output from the system to the power input into the system of approximately 12.3.

This example is set forth in more detail in FIGS. 27A and 27B. In addition, the interior reactor vessel wall temperature was measured to be approximately 3,213 degrees F., much higher than would be measured due to conventional combustion of the diesel fuel and ethyl alcohol.

Foregoing general and detailed discussion and experimental examples are intended to be illustrative of the present invention, and are not to be considered as limiting. Other variations within the spirit and scope of this invention are possible and will present themselves to those skilled in the art.

1. A method for creating an energy source comprising:
creating a hot gas in a reactor vessel by combusting diesel fuel and air in the presence of at least one mid-Z element;
directing and maintaining a laser and high voltage discharge into the hot gas thereby creating a plasma;
and
creating a rotating gas vortex surrounding the plasma, thereby producing thermal energy.

2. (canceled)

3. The method of claim 1, wherein the at least one mid-Z element comprises at least one of lithium, beryllium, boron, nitrogen, and fluorine.

4. (canceled)

5. The method of claim 1, further comprising:
raising the temperature of the plasma at least to or above a critical temperature; and
discontinuing the laser.

6. The method of claim 1, wherein the combustion fuel is mixed with water.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. The method of claim 1, further comprising:
bringing the plasma up to or above a critical temperature; and
discontinuing the laser.

30. (canceled)

31. (canceled)

32. (canceled)

33. (canceled)

34. (canceled)

35. (canceled)

36. (canceled)

37. (canceled)

38. (canceled)

39. An apparatus comprising:
a reactor vessel;
at least one fuel injector for injecting fuel into the reactor vessel;
at least one injector for injecting an oxidizer into the reactor vessel;
a source of at least one mid-Z element;
a source of radiation;
a target for the source of radiation;
a voltage source for which the target for the source of radiation is a cathode;
an anode for the voltage source substantially opposite the cathode;
at least one injector for injecting a gas to create a rotating gas vortex;
a reactor vessel cooling system; and
an exhaust port.

40. The apparatus of claim 39, wherein the source of radiation is a source of electromagnetic radiation.

41. The apparatus of claim 39, wherein the external source of radiation is at least one of a microwave source or a laser.

42. The apparatus of claim 39, wherein the source of radiation is a microwave source.

43. (canceled)

44. The apparatus of claim 39, wherein the source of radiation is at least one of a microwave source or a laser.

45. The apparatus of claim 39, wherein the reactor vessel has an open structure geometry that provides the support for creating, and maintaining a self sustaining plasma structure.

46. The apparatus of claim 39, further comprising an external heat source.

47. A method for creating an energy source comprising:
creating a hot gas in a reactor vessel by combusting fuel and air in the presence of at least one mid-Z element;
directing and maintaining a source of radiation and high voltage discharge into the hot gas thereby creating a plasma;
and
controlling the stability of the plasma, thereby producing thermal energy.

48. (canceled)

49. The method of claim 47, wherein the source of radiation is at least one of a microwave source, a radio frequency source, a laser, or electron beams.

50. The method of claim 47, wherein the fuel comprises at least a hydrocarbon.

51. (canceled)

52. The method of claim 47, wherein the plasma is stabilized by a rotating gas vortex injected into the reactor vessel between the plasma and the walls of the reactor vessel.

53. (canceled)

54. (canceled)

55. (canceled)

56. (canceled)

57. (canceled)

58. (canceled)

59. (canceled)

60. The method of claim 47, wherein the at least one mid-Z element is placed in the reactor vessel as part of the composition of the wall of the reactor.

61. (canceled)

62. (canceled)

63. (canceled)

64. (canceled)

65. (canceled)

66. The method of claim 47, further comprising:
creating a fusion reaction within a substantially closed reactor vessel;
obtaining heated exhaust from the reactor vessel; and
generating electricity from the heated exhaust.

67. (canceled)

68. (canceled)

69. The method of claim 47, wherein at least one additive comprising at least one of lithium, beryllium, boron, nitrogen, and fluorine is added to the fuel.

70. (canceled)

71. The method of claim 47, further comprising:
bringing the plasma at least up to a critical temperature; and
discontinuing the source of radiation.

72. (canceled)

73. (canceled)

74. (canceled)

75. (canceled)
